(19) United States
(12) Patent Application Publication
(10) Pub. No.: US 2023/0146881 A1
(43) Pub. Date: May 11, 2023

(54) ELECTROSPRAY PRINTER

(71) Applicant: The Research Foundation for The State University of New York, Albany, NY (US)

(72) Inventors: Bryce James Kingsley, Endicott, NY (US); Paul Rudolph Chiarot, Binghamton, NY (US)

(21) Appl. No.: 17/978,325

(22) Filed: Nov. 1, 2022

Related U.S. Application Data
(60) Provisional application No. 63/276,171, filed on Nov. 5, 2021.

(51) Int. Cl. B05B 5/025; B41J 2/06

(52) U.S. Cl. CPC B05B 5/0255; B41J 2/06; B41J 2202/01

(57) ABSTRACT

An electrospray printing system that produces conformal films includes a printhead. A housing of the printhead includes a solution reservoir operable to receive a solution that includes a print material suspended in a solvent. An electrical potential is applied to the solution to produce an electrically charged solution that is emitted from the solution reservoir towards a target substrate. Electrostatic focusing is used to guide the print material to the target substrate.

### RELATED APPLICATIONS

This application claims the benefit of U.S. Provisional Patent Application Ser. No. 63/276,171, filed on Nov. 5, 2021, the disclosure of which is hereby incorporated herein by reference in its entirety.

### FIELD OF THE DISCLOSURE

The disclosure relates to electrospray printing and electrospray printing systems.

### BACKGROUND

Various additive manufacturing or printing processes can be used to print a print material onto a target surface. One additive printing process is chemical vapor deposition (CVD). In CVD, a print material, such as a polymer print material, is formed on the target surface from precursor gases, which react or decompose to produce the desired thin film deposit. Unfortunately, CVD may require expensive instrumentation, can emit toxic gaseous by-products during reaction, and/or may be an expensive printing process.

Another additive printing process is inkjet printing. Inkjet printing can print a variety of print materials, such as conductive, insulating, and organic print materials. Although inkjet printing is typically less expensive than CVD, inkjet printing has several limitations. The limitations include disruptive evaporative effects after a volatile ink is delivered to the target surface and/or difficulty in creating conformal films.

### SUMMARY

The present disclosure relates to a printhead, an electrospray printing system, and a method of operating an electrospray printing system that produce conformal films on any type of target substrate. The electrospray printing system can be used to print a variety of print materials. Example print materials include, but are not limited to, semi-conducting materials, conducting materials, polymers, or insulating materials. The solution may be a homogeneous solution or a colloidal solution. Generally, if a print material can be included in a solution, an electrospray printing system disclosed herein can print the print material onto a target substrate.

The electrospray printing technology is material versatile and can be used to print on metal target substrates, semiconductor target substrates, and other types of target substrates. The design of the printhead uses electrostatic focusing to create different thicknesses and/or patterns with high material density. The print material is delivered to the target substrate in a dry state or in a semi-dry state, avoiding issues associated with solvent evaporation after printing. As an additive manufacturing technique, material can be delivered to a specific region of the target substrate to create fine features or large-area films. The electrospray printing does not require a direct line-of-sight to the target surface and can create highly conformal coatings. The thickness of the printed film is governed by several parameters, including, but not limited to, the electrical properties of the target substrate. Therefore, different thicknesses can be printed on multi-material substrates in a single pass. The electrospray printer is designed to be user friendly and may incorporate computer-controlled positioning of the target and/or the printhead, automated control of the printhead, and/or real-time monitoring of the electrospray printing process.

In one aspect, a printhead for an electrospray printing system includes a housing, a mixing receptacle in the housing, and an emitter in the housing. The mixing receptacle is operable to receive at a first inlet a solution and receive at a second inlet an electrical potential that is applied to the solution to produce an electrically charged solution. The solution includes a print material suspended in a solvent. The emitter is operable to receive the electrically charged solution at a third inlet and emit the electrically charged solution at an outlet. The electrical potential produces an electric field that directs electrically charged droplets towards an orifice of the printhead. Each of the electrically charged droplets include the print material suspended in the solvent. The housing may further include at least one air flow inlet operable to provide a flow of air into the printhead.

In another aspect, an electrospray printing system includes a printhead, a power supply, and a device operable to supply a solution to the printhead. The printhead includes a housing, a mixing receptacle in the housing, and an emitter in the housing. The mixing receptacle is operable to receive at a first inlet a solution and receive at a second inlet an electrical potential that is applied to the solution to produce an electrically charged solution. The solution includes a print material suspended in a solvent. The emitter is operable to output the electrically charged solution toward an orifice of the printhead. The power supply is operably connected to the mixing receptacle. After the emitter outputs the electrically charged solution, a plume of electrically charged droplets form in the printhead. The electrically charged droplets include the print material suspended in the solvent. An electric field within the printhead is operable to guide a spray of electrically charged particles to a target substrate. In certain embodiments, the electrically charged particles are electrically charged dry particles or electrically charged semi-dry particles.

In yet another aspect, a method includes receiving, at a printhead, a solution comprising a print material suspended in a solvent, and receiving, at the printhead, an electrical potential that is applied to the solution to produce an electrically charged solution. The electrically charged solution is emitted into the printhead that transitions into, within the printhead, a plume of electrically charged droplets that comprises the print material suspended in the solvent. A spray of electrically charged particles is emitted from the printhead onto a target substrate, the electrically charged particles comprising of the print material. An electric field that is created by the electrical potential guides the plume of electrically charged droplets within the printhead and guides the spray of electrically charged particles onto the target substrate.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates an electrospray printing system in accordance with the prior art;

FIG. 2 illustrates an example electrospray printing system in accordance with embodiments of the disclosure;

FIG. 3 illustrates a cross-sectional view of an example implementation of the printhead shown in the dashed box in FIG. 2 in accordance with embodiments of the disclosure;

FIG. 4 illustrates line-of-sight and non-line-of-sight electrospray printing of a component in accordance with embodiments of the disclosure;

FIG. 5 illustrates an example of a conformal dry film printed by an electrospray printing system in accordance with embodiments of the disclosure;

FIG. 6 illustrates an example of a conformal semi-dry film printed by an electrospray printing system in accordance with embodiments of the disclosure;

FIGS. 7A-7C illustrate print material deposition and pinholing in accordance with embodiments of the disclosure;

FIG. 8 illustrates a graph of film thickness over spray time in accordance with embodiments of the disclosure;

FIG. 9 illustrates an optical property of a semi-dry film that is printed by an electrospray printing system in accordance with embodiments of the disclosure;

FIG. 10 illustrates an optical property of a dry film that is printed by an electrospray printing system in accordance with embodiments of the disclosure;

FIG. 11 illustrates an example graph of example plots of a percentage of transmission versus wavelengths of light in accordance with embodiments of the disclosure;

FIG. 12A illustrates an example graph of a dielectric strength of a silicon substrate;

FIG. 12B illustrates an example graph of a dielectric strength of a film that is electrospray-printed onto a silicon substrate in accordance with embodiments of the disclosure;

FIG. 13A illustrates a water droplet on an electrospray printed particulate film in accordance with embodiments of the disclosure;

FIG. 13B illustrates a water droplet on an electrospray printed densified film in accordance with embodiments of the disclosure;

FIG. 14 illustrates a flowchart of a method of electrospray printing in accordance with embodiments of the disclosure; and

FIG. 15 illustrates a block diagram of a computing device that may be used in the electrospray printing system shown in FIG. 2 in accordance with embodiments of the disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

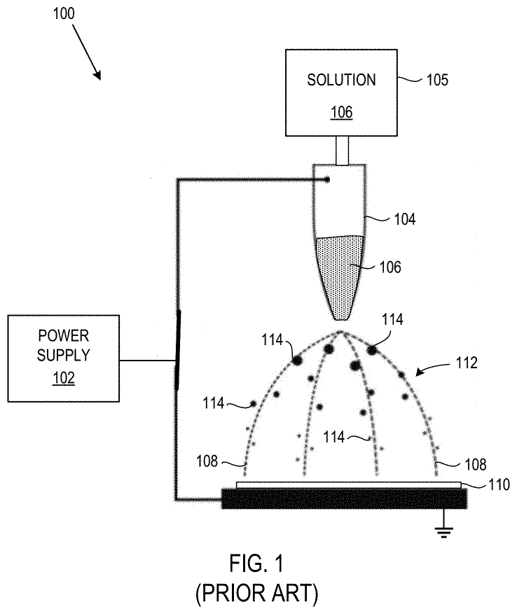

FIG. 1 illustrates an electrospray printing system 100 in accordance with the prior art. A power supply 102 is operably connected to a solution reservoir 104. A device 105 holds the solution 106 that flows into the solution reservoir 104, where the power supply 102 is used to charge particles in the solution 106 within the solution reservoir 104. The solution 106 is composed of a solute material (hereinafter “print material”) suspended in a volatile solvent (hereinafter “solvent”).

The electrical potential produced by the power supply 102 creates an electric field (represented by the dashed lines 108) between the solution reservoir 104 and a target substrate 110. The electric field is used to atomize the solution 106 into a plume 112 of electrically charged droplets 114. The electrically charged droplets 114 are sprayed onto the target substrate 110 to create a film of the print material on the target substrate 110.

As shown in FIG. 1, the unfocused electric field results in a broad deposition of the print material onto the target substrate 110. In some instances, the broad deposition of the print material results in longer spray times when a thicker or more dense film of the print material is desired.

Embodiments disclosed herein provide a printhead, an electrospray printing system, and a method of operating an electrospray printing system that produce conformal films. The technology is material versatile and can be used to print on target substrates that are, or include, metals, semiconductors, and other types of target substrates. The design of the printhead uses electrostatic focusing to deliver a print material to a target substrate in a dry state or in a semi-dry state. Both the dry state and the semi-dry state avoid issues associated with solvent evaporation after printing. As an additive manufacturing technique, the print material can be delivered to a specific region of the target substrate to create fine features or large-area films. The electrospray printing does not require a direct line-of-sight to a surface of the target substrate. A thickness of the printed film is governed by several parameters, including, but not limited to, the electrical properties of the target substrate and/or the dryness of the print material at the time of deposition. Therefore, different thicknesses can be printed on multi-material substrates in a single pass. The electrospray printer is designed to be user friendly and may incorporate computer-controlled positioning of the target substrate and/or the printhead, automated control of the printhead and/or the electrospray printing system, and/or real-time monitoring of the electrospray printing process.

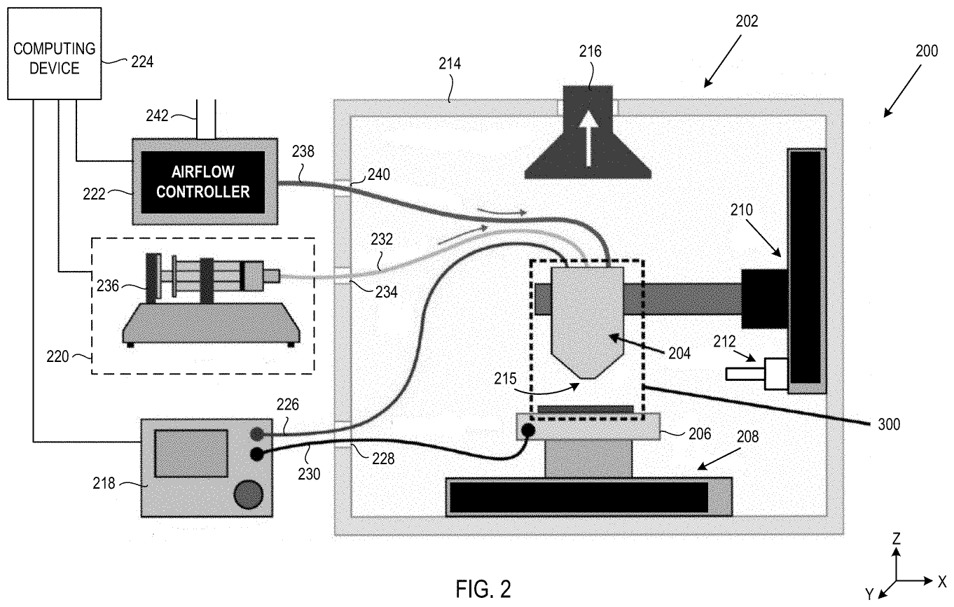

FIG. 2 illustrates an example electrospray printing system 200 in accordance with embodiments of the disclosure. A cross-sectional view of a print system 202 is shown in FIG. 2. The print system 202 includes a printhead 204 held in suspension over a print bed 206. The print bed 206 is made of, or enclosed with, a conductive material. A non-limiting nonexclusive example of the conductive material is a metal, such as aluminum.

In certain embodiments, the print bed 206 is operably attached to a first stage 208 and the printhead 204 is operably attached to a second stage 210. The first stage 208 may be operable to translate the print bed 206 in a first direction (e.g., an x-direction) and in a second direction (e.g., a y-direction), while the second stage 210 is operable to translate the printhead 204 in a third direction (e.g., a z-direction). In other embodiments, the first stage 208 and/or the second stage 210 can be operable to move differently. For example, the first stage 208 may be operable to translate the print bed 206 in the first direction, the second direction, and the third direction.

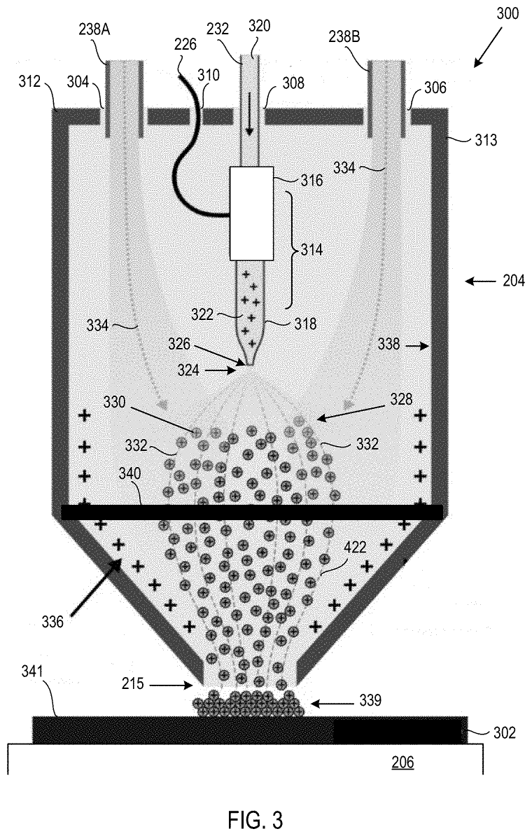

The print system 202 may further include an imaging system 212 that is positioned to provide images of an outlet of a solution receptacle within the printhead 204 (e.g., the outlet 326 of the solution reservoir 314 in FIG. 3). In some embodiments, the printhead 204 is made of a transparent dielectric material, or the printhead 204 includes a transparent window that enables the imaging system 212 to capture images of the outlet. The imaging system 212 is used to monitor the output from the outlet to ensure a stable spray (e.g., monitor a Taylor cone 324 shown in FIG. 3). The stability of the spray may be based on the electrical potential (e.g., the voltage) applied to the solution and/or the flow rate of air into the printhead 204. If captured images of the spray show an unstable spray, the applied electrical potential and/or the flow rate of the air can be increased or decreased to improve the stability of the spray. In non-limiting nonexclusive examples, the imaging system 212 may be implemented as a camera operable to capture still images, a video camera operable to capture video, or a combination of the camera and the video camera.

The printhead 204, the print bed 206, the first stage 208, the second stage 210, and the imaging system 212 are housed within an enclosure 214. A frame of the enclosure 214 may be made of any suitable material, such as aluminum. Panels can be positioned between the openings in the frame. The panels may be transparent, semi-transparent, or opaque. In a non-limiting nonexclusive example, plastic panels are positioned between the openings in the frame. Thus, the enclosure 214 fully encloses the environment within the enclosure 214.

The enclosure 214 may include a fume extractor 216 that extends from the interior of the enclosure 214 to the exterior of the enclosure 214. In certain embodiments, the fume extractor 216 is a system that uses a fan to pull fumes and particulates (e.g., volatile chemicals or particles) that are inside the enclosure 214 into a filtration system (not shown) that is outside of the enclosure 214.

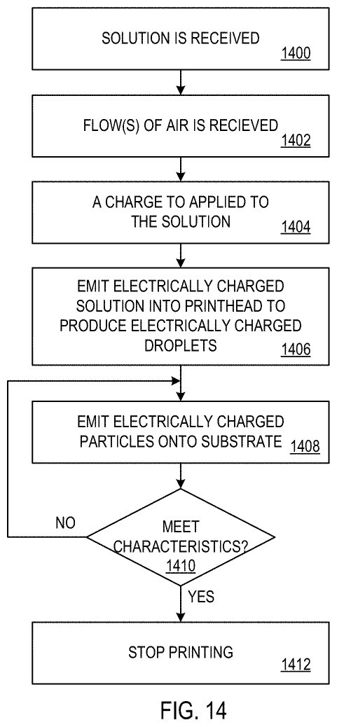

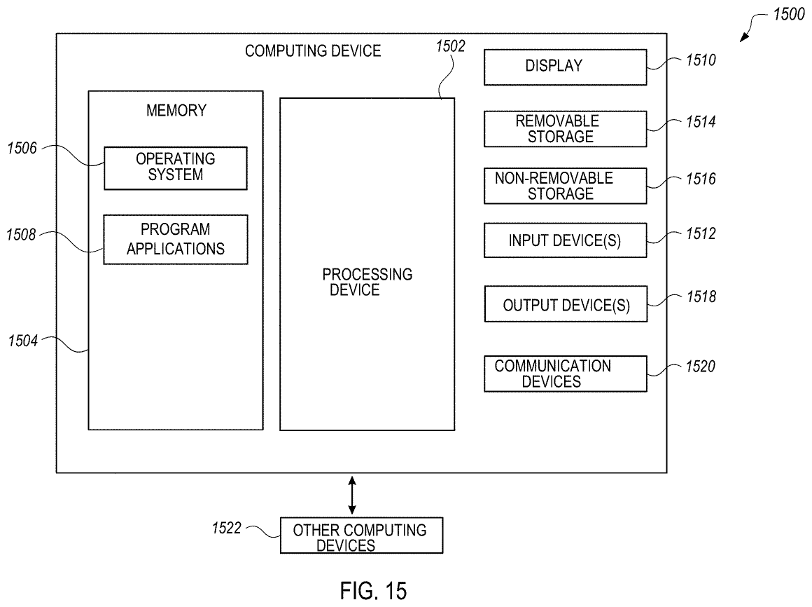

A power supply 218, a device 220, and an airflow controller 222 are be positioned outside of the enclosure 214, although other embodiments are not limited to this arrangement. One or more of the power supply 218, the device 220, and the airflow controller 222 may be positioned within the enclosure 214. In certain embodiments, the power supply 218, the device 220, and the airflow controller 222 are controlled by a computing device 224. In certain embodiments, the computing device 224 enables the power supply 218, the device 220, and/or the airflow controller 222 to be controlled remotely. For example, a second computing device (e.g., other computing devices 1422 in FIG. 14) may be operably connected to the computing device 224 to enable a user to remotely control the power supply 218, the device 220, and/or the airflow controller 222. An example implementation of the computing device 224 is shown in FIG. 15.

A positive terminal 226 of the power supply 218 extends through an opening 228 in the enclosure 214 to be inserted into the printhead 204. The positive terminal 226 is used to apply an electrical potential (e.g., a voltage) to the solution within the printhead 204. In a non-limiting nonexclusive example, the electrical potential ranges between four (4) and five (5) kilovolts (kV). A negative terminal 230 (e.g., ground) extends through the opening 228 in the enclosure 214 to be operably connected to the print bed 206. An example implementation of the printhead 204 is shown in FIG. 3.

The device 220 is operable to supply the solution to the printhead 204. One or more outlet tubes (collectively referred to as outlet tube 232) of the device 220 extend through an opening 234 in the enclosure 214 and are inserted into the printhead 204 to provide the solution to the printhead 204. In a non-limiting nonexclusive example, the device 220 is implemented as a syringe pump 236.

The airflow controller 222 is operable to supply one or more air flows to the printhead 204. One or more outlet tubes (collectively referred to as outlet tube 238) of the airflow controller 222 extend through an opening 240 in the enclosure 214 and are inserted into the printhead 204. An inlet 242 of the airflow controller 222 receives air, such as compressed air, and supplies the air flow(s) to the printhead 204.

FIG. 3 illustrates a cross-sectional view of an example implementation of the printhead 204 shown in the dashed box 300 in FIG. 2 in accordance with embodiments of the disclosure. A first outlet tube 238A of the airflow controller 222, a second outlet tube 238B of the airflow controller 222, the outlet tube 232 of the device 220, and the positive terminal 226 of the power supply 218 are inserted or attached to openings 304, 306, 308, 310, respectively, in a top surface 312 of a housing 313 of the example printhead 204. In certain embodiments, the housing 313 is made of a dielectric material. Other embodiments are not limited to this implementation.

The outlet tube 232 of the device 220 is received by a solution reservoir 314. In a non-limiting nonexclusive example, the solution reservoir 314 is a microfluidic T-junction that includes a mixing receptacle 316 and an emitter 318 operably connected to the mixing receptacle 316. The outlet tube 232 of the device 220 supplies the solution 320 to the solution reservoir 314 (e.g., the mixing receptacle 316). The positive terminal 226 of the power supply 218 is operably connected to the solution reservoir 314 (e.g., the mixing receptacle 316) to apply the electrical potential (e.g., the voltage) to the solution 320 that is within the solution reservoir 314.

The electrically charged solution 322 is output from the solution reservoir 314 (e.g., the emitter 318) into the printhead 204. In certain embodiments, a Taylor cone 324 forms within the printhead 204 outside an outlet 326 of the solution reservoir 314 (e.g., the emitter 318). In a non-limiting nonexclusive example, a size of the outlet 326 (e.g., a diameter of the outlet 326) is approximately one hundred and fifty (150) micrometers.

Within the printhead 204, the Taylor cone 324 transitions to a plume 328 of electrically charged droplets 330. A focused electric field (represented by dashed lines 332) produced by the electrical potential that is applied to the solution 320 causes the plume 328 of electrically charged droplets 330 to form into a narrow plume of electrically charged droplets 330. The focused electric field further guides the electrically charged droplets 330 toward an orifice 215 of the printhead 204. In a non-limiting nonexclusive example, a size of the orifice 215 (e.g., a diameter of the orifice 215) is in the range of tens of millimeters (e.g., approximately thirty (30) millimeters).

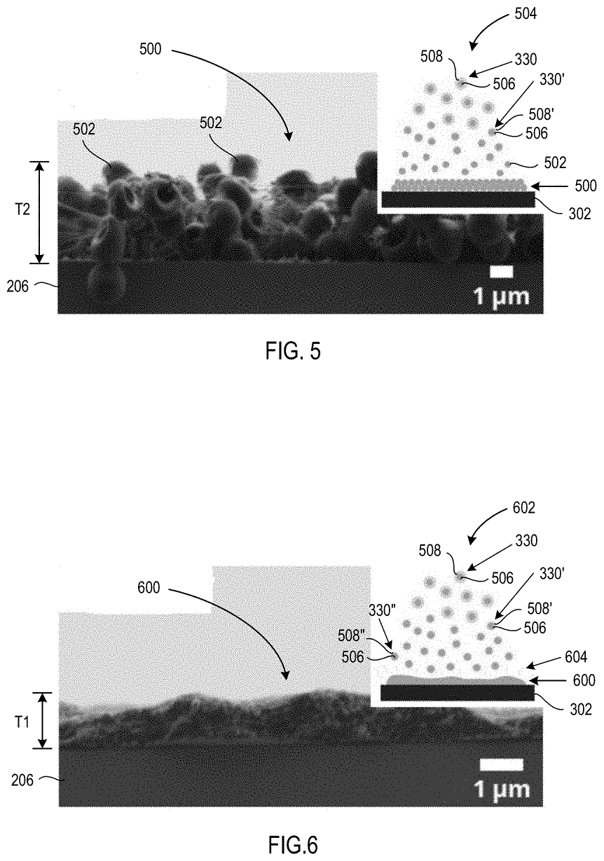

The first outlet tube 238A and the second outlet tube 238B of the airflow controller 222 are each operable to provide a flow of air into the printhead 204 to assist in evaporation of the electrically charged droplets 330 within the printhead 204. In some embodiments, the flow of air also assists in focusing the electrically charged droplets within the printhead 204. In a non-limiting nonexclusive example, the flow of air (air flows 334) is co-linear with the emitter 318 and is in the range of five (5) to ten (10) liters per minute. Rapid solvent evaporation from the electrically charged droplets 330 occurs at least within the printhead 204 in part due to the air flows 334 output from the first outlet tube 238A and the second outlet tube 238B. In some embodiments, the rapid solvent evaporation within the printhead 204 produces a spray of electrically charged dry particles within the printhead 204. A film that is formed with electrically charged dry particles is discussed in more detail in conjunction with FIG. 5. In other embodiments, slower solvent evaporation within the printhead 204 produces a spray of electrically charged semi-dry particles within the printhead 204. A film that is produced with electrically charged semi-dry particles is discussed in more detail in conjunction with FIG. 6.

Electrical charge 336 can build up on the interior surface 338 of the housing 313 of the printhead 204. The electrical charge 336 assists in focusing the electric field (represented by the dashed lines 332) and the formation of the plume 328 (the narrow plume) within the printhead 204. The focused electric field directs the spray of the electrically charged dry or semi-dry particles 339 through the orifice 215 of the printhead 204 and onto a print surface 341 of the target substrate 302. The rate of the delivery of the electrically charged dry or semi-dry particles 339 can be controlled or adjusted by adjusting the flow rate of the solution 320 into the printhead 204 (e.g., into the mixing receptacle 316) and/or by adjusting a solution mass loading (e.g., the amount of print material in the solution 320).

In certain embodiments, one or more conductive electrodes (collectively referred to as conductive electrode 340) are included within the printhead 204. The conductive electrode 340 is operably connected to ground to cause the conductive electrode 340 to be a grounded conductive electrode. The conductive electrode 340 is adjacent to at least one interior surface 338 of the housing 313. In certain embodiments, the conductive electrode 340 is adjacent all of the interior surfaces 338 of the housing 313. The interior surfaces 338 may be the vertical interior surfaces, the angled interior surfaces, and/or the top surface 312. In the illustrated embodiment, the conductive electrode 340 is shaped into a ring that is positioned along the interior surfaces 338 of the housing 313 below the solution reservoir 314 (e.g., below the emitter 318). The conductive electrode 340 facilitates in the focusing of the focused electric field, the formation of the plume 328 of the electrically charged droplets 330, and/or in reducing the amount of the electrical charge 336 that can build up on the interior surfaces 338 of the housing 313. In embodiments that omit the conductive electrode 340, a higher electrical potential may be needed to form the plume 328 of the electrically charged droplets 330. For example, an electrical potential greater than ten (10) kV may be required to form the electrospray.

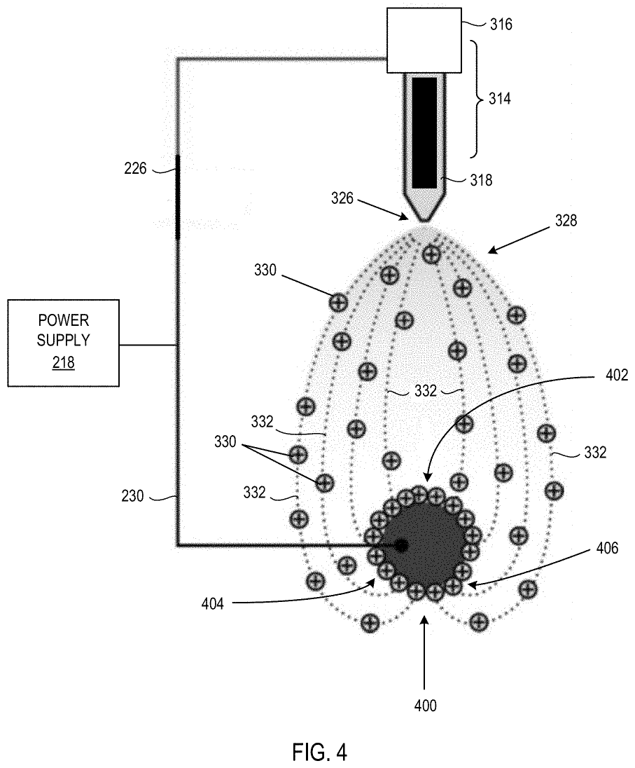

FIG. 4 illustrates line-of-sight and non-line-of-sight electrospray printing of a component 400 in accordance with embodiments of the disclosure. The housing 313 and the conductive electrode 340 are omitted for clarity. The component 400 can be suspended within the printhead (e.g., the printhead 204 in FIG. 2 and FIG. 3), or the component 400 may be positioned outside of the printhead just below or adjacent to the orifice of the printhead (e.g., the orifice 215 in FIG. 2 and FIG. 3). The component 400 is shown as an electrical wire in FIG. 4, although other embodiments are not limited to this type of component. The component 400 can have any shape, size, and/or orientation. Additionally, the component 400 may be made of any type of material.

The positive terminal 226 of the power supply 218 is operably connected to the solution reservoir 314 (e.g., the mixing receptacle 316), and the negative terminal 230 of the power supply 218 (e.g., ground) is operably connected to the component 400. The plume 328 of electrically charged droplets 330 is output from the solution reservoir 314 (e.g., the emitter 318). Although not shown in FIG. 4, a Taylor cone may form at the outlet 326 of the solution reservoir 314 (e.g., the emitter 318). The focused electric field (represented by dashed lines 332) directs electrically charged particles (e.g., electrically charged dry particles or electrically charged semi-dry particles) onto the surface of the component 400. The focused electric field guides the electrically charged particles to a portion of the surface (e.g., area 402) that is in the direct line-of-sight of the solution reservoir 314 (e.g., the emitter 318), as well as to portions of the surface that are not in the direct line-of-sight of the solution reservoir 314 (e.g., areas 404, 406). The focused electric field drives the electrically charged particles to the backside and around the geometry of the component 400. Over time, a conformal coating or film is produced over the entire surface of the component 400 without having to move the solution reservoir 314 (e.g., without moving the printhead 204) and/or without moving the component 400 (e.g., the target substrate).

FIG. 5 illustrates an example of a conformal dry film 500 that can be printed by an electrospray printing system in accordance with embodiments of the disclosure. The film 500 is comprised of electrically charged dry particles 502 and is referred to herein as a dry film or a particulate film. Some or all of the individual electrically charged dry particles 502 of the print material are discernible when examined under a microscope. In certain embodiments, the particulate film 500 is produced when a higher amount of solvent evaporates prior to delivery of the print material onto the target substrate 302. In the example embodiment, the print material is a polymer material (e.g., a polyimide), although other embodiments are not limited to this type of print material.

As shown in the graphic representation 504, the electrically charged droplets 330 initially include the print material 506 suspended in the solvent 508. The solvent 508 continues to evaporate as the electrically charged droplets 330 are directed to the target substrate 302 (e.g., while the electrically charged droplets 330 are in the printhead). This is shown by the electrically charged droplets 330′, which include the print material 506 and less solvent 508′. Prior to deposition of the print material 506 onto the target substrate 302 (e.g., while the electrically charged droplets 330 are still in the printhead), the solvent evaporates completely to produce the electrically charged dry particles 502. The electrically charged dry particles 502 are deposited onto the target substrate 302 to form the particulate film 500.

FIG. 6 illustrates an example of a conformal semi-dry film 600 that can be printed by an electrospray printing system in accordance with embodiments of the disclosure. The film 600 is comprised of electrically charged semi-dry particles and is referred to herein as a semi-dry film or a densified film. With the densified film 600, all (or nearly all) of the individual particles of the print material 506 are not discernible when examined under a microscope. As shown in FIG. 6, the composition and the surface of the densified film 600 are more continuous across the densified film 600 compared to the particulate film 500 shown in FIG. 5. Additionally, in certain embodiments, a thickness T1 of the densified film 600 is less than a thickness T2 of the particulate film 500 shown in FIG. 5.

In certain embodiments, the densified film 600 is produced when a lower amount of solvent evaporates prior to delivery of the print material onto the target substrate 302. Although the densified film 600 is semi-dry, no post-processing is needed to “dry” or cause the remaining solvent to evaporate. The amount of solvent in the densified film 600 is very low at the time of deposition onto the target substrate 302 such that the remaining solvent evaporates rapidly from the densified film 600.

As shown in the graphic representation 602, the electrically charged droplets 330 initially include the print material 506 suspended in the solvent 508. The solvent 508 evaporates as the electrically charged droplets 330 are directed to the target substrate 302 (e.g., while the electrically charged droplets 330 are in the printhead). This is shown by the electrically charged droplets 330′, which include the print material 506 and a first reduced amount of solvent 508′. When the print material 506 is deposited onto the target substrate 302, the solvent has not completely evaporated, as depicted by the electrically charged droplets 330″ that comprise the print material 506 and a second reduced amount of solvent 508″. The electrically charged droplets 330″ are deposited onto the target substrate 302 to form the densified film 600. The remaining solvent evaporates from the densified film 600 (evaporation represented by lines 604). As discussed earlier, the amount of solvent that remains in the densified film 600 is low and no post-processing of the densified film 600 is needed to “dry” or cause the remaining solvent to evaporate after deposition onto the target substrate 302.

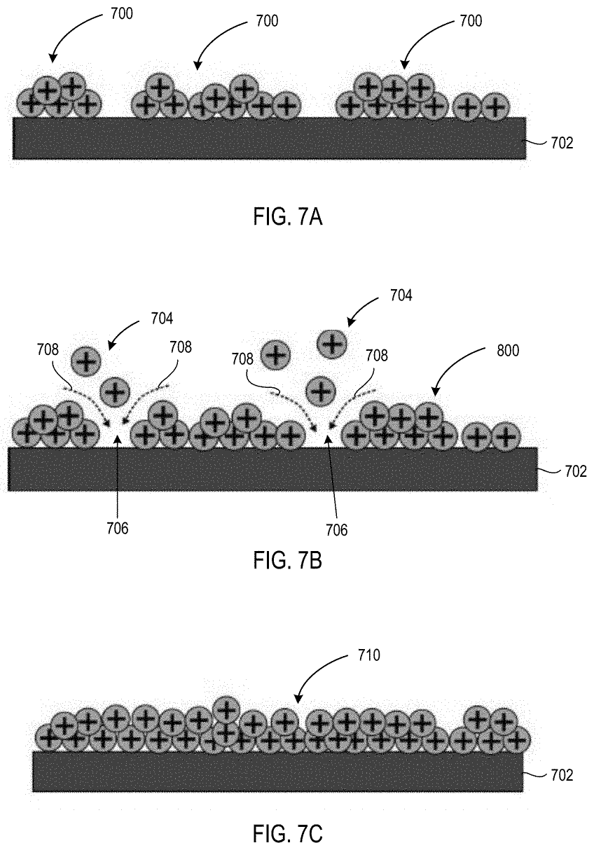

FIGS. 7A-7C illustrate print material deposition and pinholing in accordance with embodiments of the disclosure. Initially, electrically charged particles 700 are deposited on the target substrate 702, as shown in FIG. 7A. The electrically charged particles 700 can be dry particles or semi-dry particles. Although the target substrate 702 is shown as having flat or level surfaces, other target substrates may have surfaces with various topologies and/or geometries (e.g., non-uniform geometries). For example, the target substrate 702 may include one or more components (e.g., component 400 in FIG. 4) on at least one surface of the target substrate 702, or the target substrate 702 is one or more components (e.g., component 400 in FIG. 4).

As the electrically charged particles 700 continue to be deposited on the target substrate 702, the charge in the existing electrically charged particles 700 (e.g., the top layer of the electrically charged particles 700) accumulates. As new electrically charged particles 704 are emitted toward the previously printed electrically charged particles 700, the electric force of the accumulated charge repulses the new electrically charged particles 704. This repulsion causes the new electrically charged particles 704 to move and be deposited in charge-void regions 706 on the target substrate 702 that have little to no previously printed electrically charged particles 700 (movement represented by arrows 708). This charge-induced movement of the new electrically charged particles 704 due to repulsion is known as pinholing and is shown in FIG. 7B. Pinholing causes the electrically charged particles 700, 704 to be printed as a film 710 on the target substrate 702 (FIG. 7C). The growth of the film 710 is a more uniform growth without having to move the printhead and/or the target substrate 702 in order to cover the charge-void regions 706.

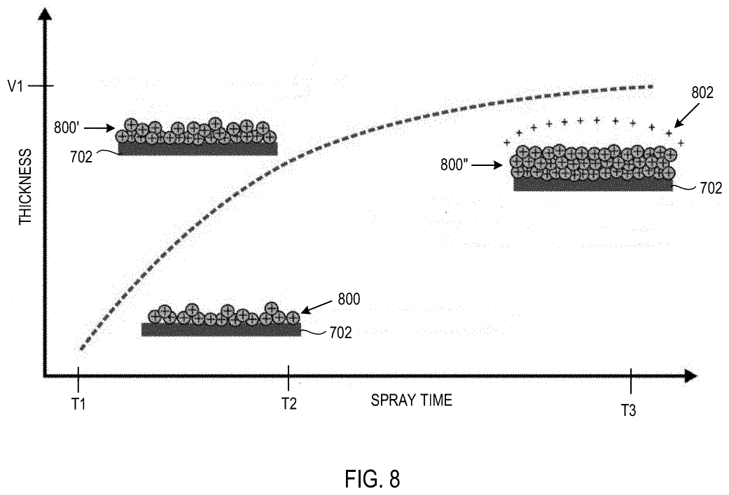

FIG. 8 illustrates a graph of film thickness over spray time in accordance with embodiments of the present disclosure. The vertical axis represents a film thickness and the horizontal axis a spray time. Initially, at time T1, the print material 800 is sprayed onto the target substrate 702. Again, although the target substrate 702 is shown as having level surfaces, the target substrate 702 can include one or more components (e.g., component 400 in FIG. 4) on at least one surface of the target substrate 702 or the target substrate 702 is one or more components (e.g., component 400 in FIG. 4).

As the spray time increases, the thickness of the film 800′ increases linearly (or substantially linearly). Additionally, as described earlier, the charge in the film 800′ accumulates as the thickness of the film 800′ increases. The linear or substantially linear growth is shown in the time period between time T1 and time T2.

At or near time T3, the accumulated charge produces a repulsive force that forms a charge-barrier 802 over the film 800″. The charge-barrier 802 functions as a self-regulating force to the thickness of the film 800″. For example, between time T2 and time T3, the thickness of the film 800″ approaches a given thickness value V1. Thus, over time, the growth or thickness of the film 800″ becomes asymptotic. This asymptotic behavior can be useful in that the thickness of the film 800″ may be controlled without the need to carefully regulate the spray time. In certain embodiments, the thickness of the film 800″ is determined by other factors, such as the electrical potential that is applied to the solution and/or a conductivity of the charged solution.

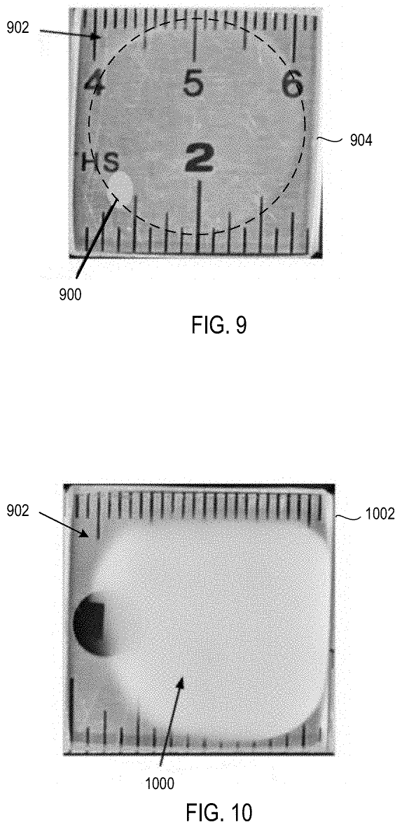

The films, including the densified films and the particulate films, can be printed based on one or more characteristics that are associated with the films. One characteristic is an optical property of the film. Films can be printed with different optical properties due to the microstructures of the films. The optical property includes a transparency of the films. FIG. 9 illustrates an optical property of a semi-dry film 900 that is printed by an electrospray printing system in accordance with embodiments of the disclosure. In the illustrated embodiment, the print material is a polymer (e.g., a polyimide). The densified film 900 is printed onto a glass substrate 902, where the glass substrate 902 is positioned on a segment of a ruler 904. As depicted, the densified film 900 is a highly transparent film. In a non-limiting nonexclusive example, a densified film that is formed with a polyimide can have an index of refraction that is comparable to the index of refraction of KAPTON® films.

FIG. 10 illustrates an optical property of a dry film 1000 that is printed by an electrospray printing system in accordance with embodiments of the disclosure. In the illustrated embodiment, the print material is a polymer (e.g., a polyimide). The film 1000 is printed onto the glass substrate 902 that is disposed on a segment of the ruler 1002. In FIG. 10, the particulate film 1000 is an opaque film. In certain embodiments, the particulate film 1000 absorbs and/or refracts most of the wavelengths in the electromagnetic spectrum. A particulate film can become increasingly opaque with longer spray times.

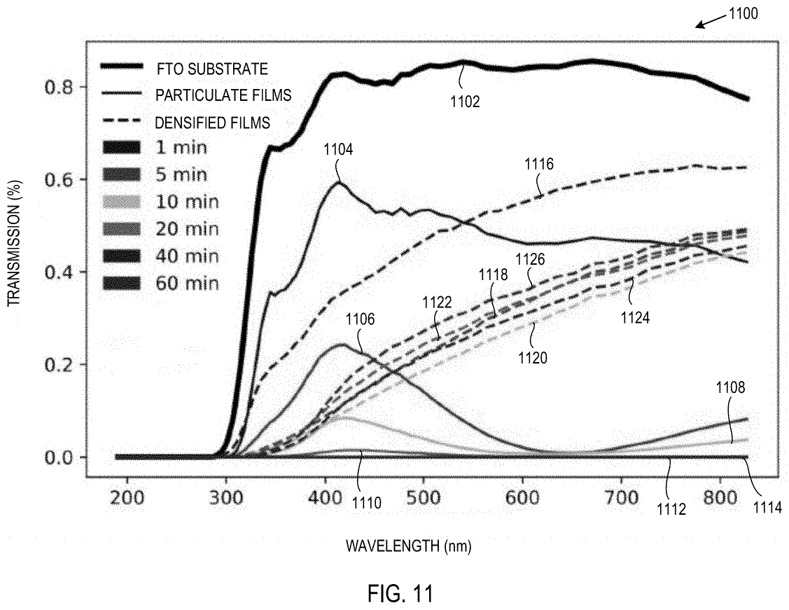

A microstructure of a film can be tuned based on solvent evaporation such that the film can be printed with an optical property that includes or is between high transparency and high opacity. An electrospray-printed film may be printed to have a selected optical property by, for example, adjusting the flow rate of the air into the printhead and/or by changing a flow rate of the solution into the printhead (e.g., into the mixing receptacle 316 in FIG. 3). FIG. 11 illustrates an example graph 1100 of example plots of a percentage of transmission versus a range of wavelengths in accordance with embodiments of the disclosure. The vertical axis represents a transmission percentage and the horizontal axis represents a range of wavelengths (in nanometers), where the wavelengths range from two hundred (200) nm to eight hundred (800) nm. As a point of reference, the transmission percentage of a glass substrate (e.g., a fluorine doped tin oxide (FTO) substrate) is represented by the plot 1102. The percentage of transmission in the plot 1102 increases starting around three hundred (300) nm and remains high up the wavelength of eight hundred (800) nm.

The percentages of transmission of multiple particulate films are based on different spray times and are represented by solid lines in the graph 1100. In the illustrated graph 1100, the plot 1104 represents the percentage of transmission across the range of wavelengths for a particulate film with a spray time of one (1) minute. The percentage of transmission in the plot 1104 begins to increase around three hundred (300) nm, peaks at a percentage of transmission of approximately sixty (60) percent at or around a wavelength of four hundred (400) nm, and decreases between the wavelengths of four hundred (400) nm to eight hundred (800) nm.

The plot 1106 represents the percentage of transmission across the range of wavelengths for a particulate film with a spray time of five (5) minutes. The percentage of transmission in the plot 1106 begins to increase around three hundred (300) nm, peaks at a percentage of transmission of approximately twenty (20) percent at or around a wavelength of four hundred (400) nm, decreases between the wavelengths of four hundred (400) nm to around six hundred and fifty (650) nm, and increases between the wavelengths of around six hundred and fifty (650) nm to eight hundred (800) nm (e.g., to a percentage of transmission of approximately ten (10) percent).

The plot 1108 represents the percentage of transmission across the range of wavelengths for a particulate film with a spray time of ten (10) minutes. The percentage of transmission in the plot 1108 begins to increase around three hundred (300) nm, peaks at a percentage of transmission of approximately ten (10) percent at or around a wavelength of four hundred (400) nm, decreases between the wavelengths of four hundred (400) nm to around six hundred and fifty (650) nm, and increases between the wavelengths of around six hundred and fifty (650) nm to eight hundred (800) nm (e.g., to a percentage of transmission of approximately five (5) percent).

The plot 1110 represents the percentage of transmission across the range of wavelengths for a particulate film with a spray time of twenty (20) minutes. The percentage of transmission in the plot 1110 begins to increase around three hundred and fifty (350) nm, peaks at a percentage of transmission of approximately five (5) percent at or around a wavelength of four hundred (400) nm, decreases between the wavelengths of four hundred (400) nm to around six hundred (600) nm, and remains at approximately zero between the wavelengths of around six hundred (600) nm to eight hundred (800) nm.

The plot 1112 represents the percentage of transmission across the range of wavelengths for a particulate film with a spray time of forty (40) minutes. The plot 1114 represents the percentage of transmission across the range of wavelengths for a particulate film with a spray time of sixty (60) minutes. The percentages of transmission in the plots 1112, 1114 are substantially at a percentage of transmission of zero (0) across the range of wavelengths. The plots 1104, 1106, 1108, 1110, 1112, 1114 illustrate the increasing opacity of the particulate films as the spray times increase.

The percentages of transmission of multiple densified films are based on different spray times and are represented by dashed lines in the graph 1100. In the illustrated graph, the plot 1116 represents the percentage of transmission across the range of wavelengths for a densified film with a spray time of one (1) minute. The percentage of transmission in the plot 1116 begins to increase around three hundred (300) nm and approaches a given percentage of transmission of approximately sixty (60) percent by the wavelength of eight hundred (800) nm.

The plot 1118 represents the percentage of transmission across the range of wavelengths for a densified film with a spray time of five (5) minutes. The percentage of transmission in the plot 1118 begins to increase around three hundred (300) nm and approaches a given percentage of transmission of approximately fifty (50) percent by the wavelength of eight hundred (800) nm.

The plot 1120 represents the percentage of transmission across the range of wavelengths for a densified film with a spray time of ten (10) minutes. The percentage of transmission in the plot 1120 begins to increase around three hundred (300) nm and approaches a given percentage of transmission of approximately forty-five (45) percent by the wavelength of eight hundred (800) nm.

The plot 1122 represents the percentage of transmission across the range of wavelengths for a densified film with a spray time of twenty (20) minutes. The percentage of transmission in the plot 1122 begins to increase around three hundred (300) nm and approaches the given percentage of transmission of approximately fifty (50) percent by the wavelength of eight hundred (800) nm.

The plot 1124 represents the percentage of transmission across the range of wavelengths for a densified film with a spray time of forty (40) minutes. The percentage of transmission in the plot 1124 begins to increase around three hundred (300) nm and approaches the given percentage of transmission of approximately forty-five (45) percent by the wavelength of eight hundred (800) nm.

The plot 1126 represents the percentage of transmission across the range of wavelengths for a densified film with a spray time of sixty (60) minutes. The percentage of transmission in the plot 1126 begins to increase around three hundred (300) nm and approaches the given percentage of transmission of approximately fifty (50) percent by the wavelength of eight hundred (800) nm. The plots 1116, 1118, 1120, 1122, 1124, 1126 illustrate the increasing transparency of the densified films as the spray times increase. Except for the plot 1116, the percentages of transmission in the plots 1118, 1120, 1122, 1124, 1126 all reach around forty-five (45) to fifty (50) percent by the end of the wavelength range. In the plot 1116, the percentage of transmission reaches around sixty (60) percent by the end of the wavelength range.

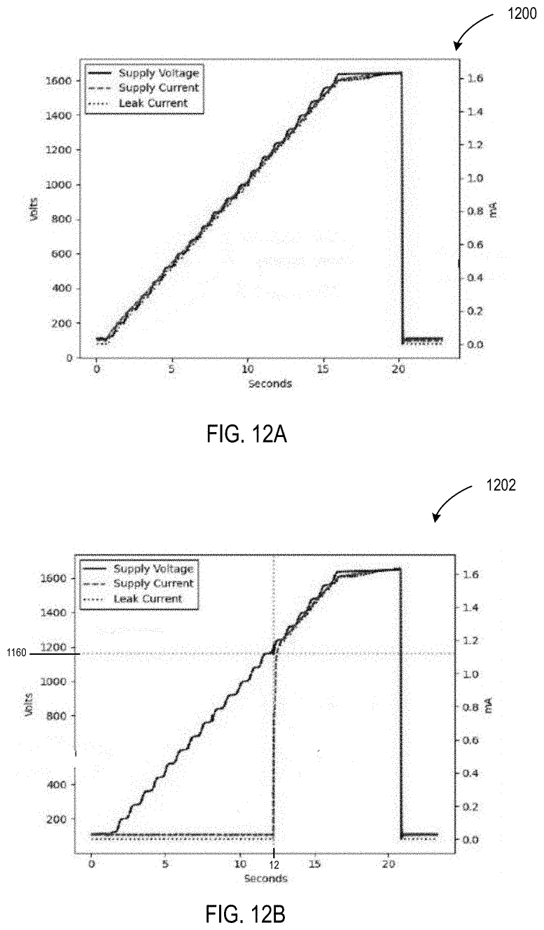

The electrospray-printed films can have additional characteristics and may be printed based on one or more selected characteristics. One additional characteristic of an electrospray-printed film is a dielectric strength of the electrospray-printed film. FIG. 12A illustrates an example graph 1200 of a dielectric strength of a silicon substrate, and FIG. 12B illustrates an example graph 1202 of a dielectric strength of a film that is electrospray-printed onto a silicon substrate in accordance with embodiments of the disclosure. The horizontal axis represents time (in seconds), the right vertical axis represents current (in milliamps (mA)), and the left vertical axis represents volts. The silicon substrate is clamped between two metal electrodes and an increasing voltage is applied to one metal electrode. Similarly, the film-coated silicon substrate is clamped between the two metal electrodes and an increasing voltage is applied to one metal electrode that is in contact with the film. The dielectric strengths of the silicon substrate and the film coating on the silicon substrate are determined by how much time passes before a current breaks through and propagates in the silicon substrate and the voltage that were applied at the time of breakthrough.

As shown in FIG. 12A, a current breaks through very quickly (e.g., after one (1) to two (2) seconds) after application of approximately one hundred (100) volts to the silicon substrate. However, as shown in FIG. 12B, a current does not break through immediately after the application of the volts to the film. Instead, the current breaks through at or near twelve (12) seconds and at approximately one thousand, one hundred, and sixty (1160) volts, and the current propagates through the film to the silicon substrate. The twelve second time delay and the voltage at breakthrough in FIG. 12B indicate the film has a higher dielectric strength compared to the silicon substrate.

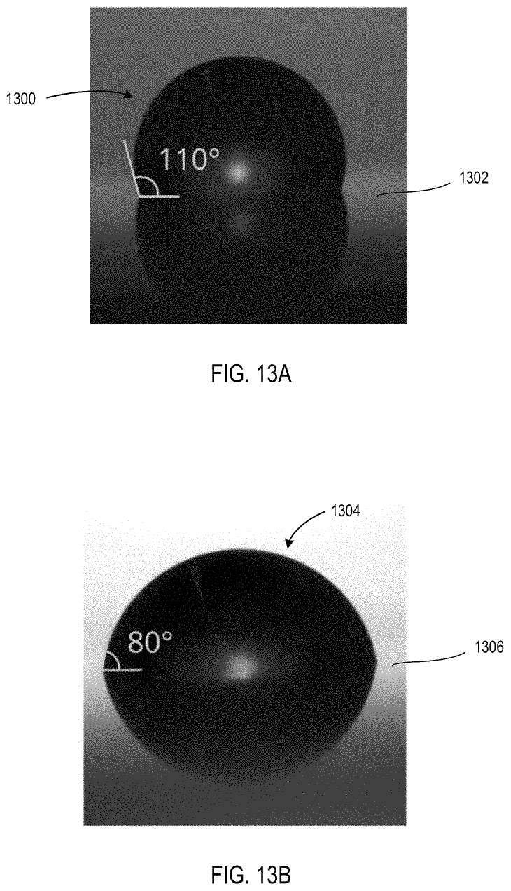

Another characteristic is a hydrophobicity of an electrospray-printed film. In certain embodiments, hydrophobicity also depends on whether the film is a dry film or a semi-dry film. For example, an underlying silicon substrate is moderately hydrophilic, with a water contact angle of approximately fifty (50) to sixty (60) degrees. In contrast, electrospray-printed particulate (dry) films, such as a dry polyimide film, are also moderately hydrophobic but with an average water contact angle of one hundred and ten (110) degrees. FIG. 13A illustrates a water droplet 1300 on an electrospray printed particulate film 1302 in accordance with embodiments of the disclosure. Moderate levels of hydrophobicity can reduce moisture penetration into and through the films. Additionally, moderate levels of hydrophobicity can provide good resistance to corrosion.

In some instances, due to the smoother surfaces, densified (semi-dry) films can be more hydrophilic compared to particulate films. FIG. 13B illustrates a water droplet 1304 on an electrospray printed densified film 1306 in accordance with embodiments of the disclosure. As shown, a densified film may have an average water contact angle of eighty (80) degrees.

FIG. 14 illustrates a flowchart of a method of electrospray printing in accordance with embodiments of the disclosure. Initially, as shown in block 1400, a flow of the solution is received by the printhead (e.g., by the mixing receptacle 316 in FIG. 3). One or more flows of air are received by the printhead at block 1402. At block 1404, a charge or an electrical potential is applied to the solution to produce an electrically charged solution. In the example embodiment shown in FIG. 3, the electrical potential is applied to the solution in the mixing receptacle 316 to produce the electrically charged solution.

The electrically charged solution is emitted into the printhead to produce the narrow plume of electrically charged droplets (block 1406). The solvent in the electrically charged droplets begins to evaporate thereafter to produce a spray of electrically charged dry particles or electrically charged semi-dry particles. As described earlier, the one or more flows of air assist in the evaporation process.

Next, as shown in block 1408, the electrically charged particles (e.g., dry particles or semi-dry particles) are then deposited onto a target substrate. The target substrate may have level or uniform surfaces or at least one non-uniform surface. For example, the target substrate can have one or more components on at least one surface, or the target substrate may be one or more components (e.g., component 400 in FIG. 4). A focused electric field that is created by the electrical potential guides the narrow plume of electrically charged droplets within the printhead and guides the spray of electrically charged particles onto the target substrate.

A determination is made at block 1410 as to whether the electrospray-printed film has achieved one or more characteristics of a film. The one or more characteristics include, but are not limited to, a selected thickness, an optical property, a dielectric strength, and/or a level of hydrophobicity. If a determination is made that the printed film has not achieved the one or more characteristics, the method returns to block 1408 where the printing of the film continues. When a determination is made at block 1410 that the printed film has achieved the one or more characteristics, the method passes to block 1412 where the printing process ends.

As should be appreciated, FIG. 14 is described for purposes of illustrating an example method and is not intended to limit the disclosure to a particular sequence of blocks. One or more blocks may be added or omitted. For example, block 1410 can be omitted in some embodiments. Additionally or alternatively, some of the blocks may be performed in parallel rather than in sequence. For example, blocks 1400 and 1402, or blocks 1400, 1402, and 1404, can be performed in parallel in certain embodiments.

FIG. 15 is a block diagram of a computing device 1500 that can be used as the computing device 224 shown in FIG. 2 in accordance with embodiments of the disclosure. Optionally, the computing device 1500 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media. Some or all of the components in the computing device 1500 may further be implemented in other types of devices, such as any device that is operable to include one or more sensor modules and at least one input surface.

The example computing device 1500 includes a processing device 1502 and a memory 1504 (e.g., a storage device). Any suitable processing device 1502 can be used. For example, the processing device 1502 may be a microprocessor, an application specific integrated circuit, a field programmable gate array, or combinations thereof.

Depending on the configuration and type of the computing device 1500, the memory 1504 may comprise, but is not limited to, volatile storage (e.g., random access memory), non-volatile storage (e.g., read-only memory), flash memory, or any combination of such memories. The memory 1504 may include a number of program applications and data files, such as an operating system 1506 and one or more program applications 1508. The one or more program applications 1508 may include a graphical user interface program and at least one control applications. In some instances, at least one program application is operable to cause one or more operations described herein to be performed. For example, a program application can be used to control, or cause to be controlled, one or more operations of the airflow controller 222, the device 220, and/or the power supply 218 shown in FIG. 2. The one or more program applications 1508 can comprise processor-executable instructions, that when executed by the processing device 1502, cause operations to be performed.

The operating system 1506, for example, may be suitable for controlling the operation of the computing device 1500. Furthermore, embodiments of the disclosure may be practiced in conjunction with a graphics library, other operating systems, or any other application program and is not limited to any particular application or system.

The computing device 1500 may have additional features or functionality. For example, the computing device 1500 can include a display 1510 and one or more input devices 1512 that allow a user to enter information into the computing device 1500. The input device(s) 1512 can include one or more buttons, a keyboard, a trackpad, a mouse, a pen, a sound or voice input device, or an audio input (e.g., a microphone jack). The display 1510 may also function as an input device (e.g., a touch-sensitive display that accepts touch and/or force inputs).

The computing device 1500 may also include additional storage devices such as a removable storage device 1514 and a non-removable storage device 1516. The removable storage device 1514 and the non-removable storage device 1516 are operable to store processor-executable instructions, that when executed by the processing device 1502, may cause operations to be performed. The memory 1504, the removable storage device 1514, and/or the non-removable storage device 1516 may include RAM, ROM, electrically erasable read-only memory (EEPROM), flash memory or other memory technology, CD-ROM, digital versatile disks (DVD) or other optical storage, magnetic storage devices, or any other article of manufacture which can be used to store information, and which can be accessed by the computing device 1500. In one embodiment, the memory 1504, the removable storage device 1514, and the non-removable storage device 1516 do not include a carrier wave or other propagated or modulated data signal.

The computing device 1500 may include one or more output devices 1518 such as a display (e.g., display 1510), an audio transducer (e.g., a speaker), a visual indicator (e.g., a light emitting diode), a vibration transducer for providing the user with tactile feedback (e.g., haptic feedback), an audio output (e.g., a headphone jack), or a video output (e.g., a HDMI port) for sending signals to or receiving signals from an external device. The aforementioned devices are examples and others may be used.

The computing device 1500 may also include one or more wired or wireless communication devices 1520 allowing communications with other computing devices 1522. Examples of suitable communication devices 1520 include, but are not limited to, a radio frequency (RF) transmitter, receiver, and/or transceiver circuitry, a universal serial bus (USB), and/or parallel and/or serial ports.

As should be appreciated, FIG. 15 is described for purposes of illustrating example components and is not intended to limit the disclosure to a particular combination of hardware or software components. In other embodiments, the computing device 1500 can include additional or fewer components than the components shown in FIG. 15. For example, a computing device may omit the removable storage device 1514 and/or the non-removable storage device 1516.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. A printhead for an electrospray printing system, the printhead comprising:
a housing;
a mixing receptacle in the housing and operable to receive at a first inlet a solution and receive at a second inlet an electrical potential that is applied to the solution to produce an electrically charged solution, the solution comprising a print material suspended in a solvent;
an emitter in the housing and operable to receive the electrically charged solution at a third inlet and emit the electrically charged solution at an outlet, the electrical potential producing an electric field that directs electrically charged droplets towards an orifice of the printhead, the electrically charged droplets comprising the print material suspended in the solvent; and
at least one air flow inlet in the housing and operable to provide a flow of air into the printhead.

2. The printhead of claim 1, wherein the housing is made of a dielectric material.

3. The printhead of claim 1, further comprising a grounded conductive electrode below the emitter in the printhead and adjacent to at least one side of the housing.

4. The printhead of claim 1, wherein the mixing receptacle and the emitter are part of a microfluidic T-junction.

5. The printhead of claim 1, wherein the print material comprises a semi-conducting material, a conducting material, a polymer, or an insulating material.

6. The printhead of claim 1, wherein the solution is a homogeneous solution or a colloidal solution.

7. An electrospray printing system, comprising:
a printhead, comprising:
a housing;
a mixing receptacle in the housing and operable to receive at a first inlet a solution and receive at a second inlet an electrical potential that is applied to the solution to produce an electrically charged solution, the solution comprising a print material suspended in a solvent; and
an emitter in the housing and operable to output the electrically charged solution toward an orifice of the printhead;
a power supply operably connected to the mixing receptacle; and
a device operable to supply the solution to the mixing receptacle, wherein:
after the electrically charged solution is emitted from the emitter, a plume of electrically charged droplets form in the printhead, the electrically charged droplets comprising the print material suspended in the solvent; and
the electrical potential produces an electric field within the printhead that is operable to guide a spray of electrically charged particles to a target substrate, the electrically charged particles comprising the print material.

8. The electrospray printing system of claim 7, wherein the printhead further comprises a grounded conductive electrode below the emitter in the printhead and adjacent to at least one side of the housing.

9. The electrospray printing system of claim 7, wherein:
the printhead further comprises at least one third inlet; and
the electrospray printing system further comprises an airflow controller operable to supply air to the at least one third inlet.

10. The electrospray printing system of claim 9, further comprising a computing device that is operably connected to at least one of the airflow controller, the device, or the power supply.

11. The electrospray printing system of claim 7, wherein the mixing receptacle and the emitter are part of a microfluidic T-junction.

12. The electrospray printing system of claim 7, wherein the printhead is included in an enclosure.

13. The electrospray printing system of claim 7, further comprising a print bed below the printhead, wherein the target substrate is on the print bed.

14. The electrospray printing system of claim 13, further comprising:
a first stage that is operably connected to the print bed; and
a second stage that is operably connected to the printhead, wherein:
the first stage is operable to translate the print bed in at least one direction; and
the second stage is operable to translate the printhead in at least one direction.

15. The electrospray printing system of claim 7, further comprising a stage that is operably connected to the print bed and operable to translate the print bed in a first direction, a second direction, and a third direction.

16. The electrospray printing system of claim 7, further comprising an imaging system operable to monitor the plume of electrically charged droplets.

17. The electrospray printing system of claim 7, wherein the spray of electrically charged particles comprises one of:
a spray of electrically charged dry particles; or
a spray of electrically charged semi-dry particles.

18. A method of electrospray printing, the method comprising:
receiving, at a printhead, a solution comprising a print material suspended in a solvent;
receiving, at the printhead, an electrical potential that is applied to the solution to produce an electrically charged solution;
emitting, into the printhead, the electrically charged solution that transitions into, within the printhead, a plume of electrically charged droplets that comprise the print material suspended in the solvent; and
emitting, onto a target substrate, a spray of electrically charged particles, the electrically charged particles comprising the print material, wherein an electric field that is created by the electrical potential guides the plume of electrically charged droplets within the printhead and guides the spray of electrically charged particles onto the target substrate.

19. The method of claim 18, further comprising determining whether the print material on the target substrate meets one or more characteristics associated with a film of the print material, the one or more characteristics comprising:
an optical property of the film;
a dielectric strength of the film; or
a hydrophobicity of the film.

20. The method of claim 18, further comprising determining whether the print material on the target substrate meets one or more characteristics associated with a film of the print material, the one or more characteristics comprising a thickness of the film of the print material.
